(19) United States
(12) Patent Application Publication
(10) Pub. No.: US 2024/0347764 A1
(43) Pub. Date: Oct. 17, 2024

(54) SURFACE TREATMENT OF A SULFIDE GLASS SOLID ELECTROLYTE LAYER

(71) Applicant: PolyPlus Battery Company, Berkeley, CA (US)

(72) Inventors: Steven J. Visco, Berkeley, CA (US); Vitaliy Nimon, Berkeley, CA (US); Alexei Petrov, Berkeley, CA (US); Yevgeniy S. Nimon, Berkeley, CA (US); Bruce D. Katz, Berkeley, CA (US)

(21) Appl. No.: 18/671,779

(22) Filed: May 22, 2024

Related U.S. Application Data
(63) Continuation of application No. 17/303,708, filed on Jun. 4, 2021, now Pat. No. 12,021,187.
(60) Provisional application No. 63/061,126, filed on Aug. 4, 2020.

(51) Int. Cl. H01M 10/0562; C03C 3/32; C03C 4/14; C03C 15/02; H01M 10/0525

(52) U.S. Cl. CPC H01M 10/0562; C03C 3/321; C03C 4/14; C03C 15/02; H01M 10/0525; C03C 2204/00; H01M 2300/0068

(57) ABSTRACT

Chemically treating ionically conductive sulfide glass solid electrolyte separators or separator layers can improve performance. In particular, treatment involving chemically etching a surface or surface region of the sulfide glass separator to blunt, lessen or remove edge defects or surface flaws, and/or to enhance surface smoothness is cost effective, reliable and well suited for high production environments compared to physical methods of removing scratches or smoothing surfaces, such as mechanical grinding and polishing.

### STATEMENT OF GOVERNMENT SUPPORT

This invention was made with Government support under Award No.: DE-AR0000772 awarded by the Advanced Research Projects Agency-Energy (ARPA-E), U.S. Department of Energy. The Government has certain rights in this invention.

### CROSS-REFERENCE TO RELATED APPLICATIONS

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

### 1. Field

This disclosure relates to batteries, in particular batteries with a glass electrolyte separator based on lithium sulfide. Sulfide glass electrolyte sheets can be strengthened via removal of surface and edge flaws, such as by wet chemical etching. Lithium sulfide glass etching media and techniques are also described.

### 2. Description of Related Art

Theoretically, the strength of a solid electrolyte glass, in particular of a Li ion conducting sulfide glass sheet, is determined by the glass atomic bond strength. However, the practical strength of a solid electrolyte strongly depends on the presence of surface flaws and edge defects. Under realistic glass and battery processing conditions, cracks are oftentimes caused by the presence of edge defects, which may arise during trimming or cutting a web of ionically conductive glass when sizing the glass as a solid electrolyte separator in a battery cell. Mechanical polishing of solid electrolyte surfaces to remove defects and smooth surfaces is both time consuming and expensive and involves handling of particulate waste products. Accordingly, there is a need for improved methods of smoothing and removing edge defects and surface flaws that may be present in manufactured sheets of glassy sulfide electrolytes.

### SUMMARY

The present disclosure provides a method for chemically treating ionically conductive sulfide glass solid electrolyte separators or separator layers. In particular, the treatment involves chemically etching a surface or surface region of the sulfide glass separator to blunt, lessen or remove edge defects or surface flaws, and/or to enhance surface smoothness. Compared to physical methods of removing scratches or smoothing surfaces, such as mechanical grinding and polishing, a chemical etching treatment, as described herein, is cost effective, reliable and well suited for high production environments.

In one aspect the present disclosure provides a method for chemically etching an ion conductive sulfide glass solid electrolyte article by contacting a surface of the glass electrolyte with etching media. In accordance with this aspect of the disclosure, in various embodiments the glass electrolyte may be in the form of a sheet or membrane, or more generally layer-like, and the chemical etching may be performed on one or both major opposing surfaces and/or peripheral edge surfaces. Theoretically, the strength of the sulfide glass sheet is determined by the glass atomic bond strength. However, practical strength often strongly depends on the lack of surface flaws and edge defects. The etching process described herein may be used to remove or polish defects such as scratches and edge protrusions and to enhance surface smoothness and improve surface uniformity and homogeneity, and thereby improve mechanical strength of the sulfide glass solid electrolyte sheets and membranes, facilitating high yield and improving battery performance.

In various embodiments, the chemically etched sulfide glass separator is a self-supporting or substrate-less sheet or web of ionically conductive sulfide glass (e.g., a glass sheet), and the etching treatment improves the structural strength of the glass electrolyte, which, in turn, enhances manufacturing yield and facilitates roll to roll processing.

In various embodiments the method involves applying or exposing a chemical etching media to a surface or surface region of a Li ion conducting sulfide glass solid electrolyte. In some embodiments the etching media is liquid phase (i.e., wet or liquid etching), and in other embodiments the etching media is a gas or vapor (i.e., dry or gaseous/vapor phase etching). It is also contemplated that the chemical etch process involves both wet and dry etching (e.g., simultaneously or sequentially).

Methods of application for wet etching include, but are not limited to, spraying, brushing, dripping, dip coating or spin coating the etching media onto the sulfide glass electrolyte or conveyance of the glass electrolyte through or into an etching bath or cartridge containing etching media. In a particular embodiment, etching is achieved by conveying the Li ion conductive sulfide glass sheet (e.g., in the form of a web) through an etching bath or etching cartridge, in line with continuous roll to roll processing and other processing steps. In various embodiments, prior to chemical etching, a masking material is applied or positioned to cover one or more portions of the glass sheet in order to protect those portions from exposure to the etching media.

In various embodiments, the active etchant species is water (i.e., water molecules). In various embodiments the chemical etching media is a liquid solution of water dissolved in a carrier solvent that is chemically inert in direct contact with the sulfide glass solid electrolyte. Sulfide glass solid electrolytes are highly sensitive to water, and conventional etching solutions would immediately attack and decompose the glass. It is therefore somewhat counter-intuitive that in accordance with various embodiments of the present disclosure, the etchant is water (i.e., water molecules), and the etching mechanism is hydrolysis. In accordance with the present disclosure, a key aspect to hydrolytic etching of a sulfide glass solid electrolyte is controlling the extent of etching and the etching rate. In various embodiments, this is achieved by formulating an etching solution that includes a low concentration of water molecules (as etchant) mixed with an inert carrier solvent (e.g., aprotic organic solvents such as glymes and acetonitrile). In other embodiments organic carbonic acids (e.g., formic acid, acetic acid, propionic acid, butyric acid, oxalic acid, and malonic acid) have been discovered to be effective etchants for sulfide glass solid electrolyte; for instance, when diluted in an appropriate inert carrier solvent.

In another aspect the present disclosure provides compositions that are usefully employed for chemically etching ionically conductive sulfide glass solid electrolytes. In various embodiments the etching solutions are prepared and dispensed into bottles or containers, and may be sold to battery or battery component manufacturers or processors as a sulfide glass solid electrolyte etching solution.

In yet other aspects the etching methods described herein may be utilized to structuralize the edges of a sulfide glass solid electrolyte separator sheet in order to facilitate edge seals, such as sealing the glass separator to an adjacent battery component or to a second glass separator.

### BRIEF DESCRIPTION OF THE DRAWING

FIG. 1 illustrates sulfide glass sheet/membranes having various useful edge shapes in accordance with embodiments.

### DETAILED DESCRIPTION

Reference will now be made in detail to specific embodiments. Examples of the specific embodiments are illustrated in the accompanying drawings. While the disclosure will be described in conjunction with these specific embodiments, it will be understood that it is not intended to limit the disclosure to such specific embodiments. On the contrary, it is intended to cover alternatives, modifications, and equivalents as may be included within the spirit and scope of the disclosure as defined by the appended claims. In the following description, numerous specific details are set forth in order to provide a thorough understanding of the present disclosure. Embodiments described in the present disclosure may be practiced without some or all of these specific details. In other instances, well known process operations have not been described in detail in order not to unnecessarily obscure the present disclosure.

When used in combination with “comprising,” “a method comprising,” “a device comprising” or similar language in this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

In one aspect the present disclosure provides methods for chemically strengthening a Li ion conducting sulfide glass solid electrolyte. In various embodiments the sulfide glass solid electrolyte is in the form of a sheet as described in U.S. Pat. No. 10,164,289, hereby incorporated by reference for its disclosure relating to sulfide glass solid electrolyte structure, fabrication and composition. Non-limiting examples of sulfide glass solid electrolyte compositions that may be fabricated into a glass sheet separator include lithium phosphorous sulfide, lithium phosphorous oxysulfide, lithium boron sulfide, lithium boron oxysulfide, lithium boron phosphorous oxysulfide, lithium silicon sulfide, lithium silicon oxysulfide, lithium germanium sulfide, lithium germanium oxysulfide, lithium arsenic sulfide, lithium arsenic oxysulfide, lithium selenium sulfide, lithium selenium oxysulfide, lithium aluminum sulfide, lithium aluminum oxysulfide, and combinations thereof.

The present disclosure is not limited to any particular sulfide glass composition. However, it is particularly useful for sulfide glasses that are highly sensitive to water, and decompose in the presence of excess water. For this reason it is somewhat counter intuitive that in various embodiments the active etchant is water (i.e., water molecules). Indeed, conventional etching solutions which may be used to textualize or strengthen structural silicate glasses are aqueous acids that are chemically incompatible in contact with sulfide glass solid electrolytes and therefore entirely unsuitable for use herein as an etching media.

In accordance with the present disclosure, in various embodiments the chemical etching process is a hydrolytic etch that involves hydrolysis at the sulfide glass solid electrolyte surface, the etching media including water molecules as the active etchant (e.g., liquid phase or vapor phase). In the presence of water or its vapor, ionically conductive sulfide glasses generally undergo rapid hydrolysis followed by evolution of hydrogen gas. In various embodiments the hydrolysis rate may be reduced and controlled by mixing water with one or more non-aqueous solvents as the etching media. For instance, using non-aqueous solvents mixed with a low concentration of water as the chemical etchant. In various embodiments the concentration of water in the etching solution is between 0.01 to 2 Molar, and in particular embodiments, the etching solution is between 0.01 to 0.1 Molar or between 0.1 to 0.2 Molar or between 0.2 to 0.5 Molar. For example, such mixtures of water with acetonitrile or glymes, such as monoglyme (DME), may be used to decrease the rate of glass etching via hydrolysis. In other embodiments a gaseous mixture of water vapor and a carrier gas for which the glass sheet is inert may be used for controlling the etching rate. For example, the gaseous etching media may be a mixture of water vapor (as the active etchant) with nitrogen or argon as the carrier gas.

In various embodiments hydrolytic etching of the sulfide glass sheet produces a hydrolysis product, such as a salt, that is poorly soluble in water and the other non-aqueous solvents which are used in the etching media as an inert carrier. The presence of insoluble products can lead to the formation of a solid precipitate on the glass surface and a progressive reduction in the rate of surface etching. For instance, hydrolysis of Li2S-P2S5 glasses leads to formation of lithium orthophosphate having low solubility in water. To mitigate solid precipitation taking place during the etching process, in various embodiments the etching media includes a solid product dissolving additive that is able to dissolve otherwise insoluble products resulting from the hydrolytic etch. In various embodiments the dissolving additive is an inorganic acid such as hydrochloric acid or sulfuric acid. In various embodiments the acid is dissolved in the carrier solvent. For instance, a nitrile such as acetonitrile is a particular suitable carrier solvent as it is inert in contact with the sulfide glass solid electrolyte and miscible with inorganic acids. For instance, concentrations of the dissolving additive may be in the range of 0.1 to 5 vol %. In a particular embodiment the etching media is a mixture of acetonitrile, water, and hydrochloric acid (e.g., having a hydrochloric acid concentration in the range of 0.1 to 5 vol % and a concentration of water in the range of 0.01 to 2 Molar). Because some inorganic acids are soluble in acetonitrile, it is contemplated to use low concentrations of hydrochloric or sulfuric acid in acetonitrile as the etching media. In various embodiments the process involves etching a surface or surface region of the sulfide glass solid electrolyte followed by rinsing the surface with an excess of acetonitrile, which does not react with sulfide glasses.

In various embodiments organic carbonic acids are used as the etchant, and, in particular, formic, acetic, propionic, butyric, oxalic, and malonic acids.

Liquid formic, acetic, propionic and butyric acids are miscible with aprotic solvents that are not reactive with sulfide glasses, and in particular glymes and organic carbonates. The solid carbonic acids such as oxalic and malonic acids have significant solubility in these solvents. In various embodiments, to control the rate of glass hydrolysis (or completely eliminate it), mixtures of formic, acetic, propionic and butyric acids with glymes, in particular dimethyl ether (DME), diglyme and triglyme may be used as carrier solvent, and/or organic carbonates, in particular, dimethyl carbonate (DMC).

The carbonic acid based etching media may be used in liquid phase. It is also contemplated to use a vapor of carbonic acids or their mixtures with carrier gases (e.g., nitrogen or argon). Regulation of the acid vapor pressure may be achieved by controlling the temperature and/or adjusting the ratio between the acid in the vapor phase and the carrier gas.

In various embodiments, the extent of etching may be controlled, in part, by modifying the composition of the etching media, as described above, as well as the duration of etching. Etching times may vary from seconds to minutes depending on the type of flaw or defect and more generally on the amount of material to be removed. In various embodiments these parameters are selected to remove an equivalent thickness of glass of about 0.1, 0.3, 0.5, 1.0, or about 5.0 microns, and in some embodiments, it is contemplated to remove more than 5 microns (e.g., between 5 to 10 microns) of glass.

In various embodiments the chemical etching process involves multiple etching steps. For instance, an initial controlled hydrolysis step using a water-based etchant followed by applying an acidic solution onto the etched surface to dissolve insoluble products formed during the hydrolytic etch, and especially those precipitates with low solubility in water. Once any surface precipitates or sludge has been removed by acid dissolution, a final rinsing may be applied to remove any residual products (water and acids) using aprotic solvent(s), such as glymes and organic carbonates.

In various embodiments a mask may be used to limit exposure of the etching media to only those areas intended for etching and material/defect removal. For instance, in various embodiments it is particularly important to etch the edges of the glass sheet or web in order to remove flaws that may result from trimming the edges during glass sheet manufacturing. In such embodiments the mask is positioned to cover the major opposing surfaces of the glass sheet while only exposing a narrow width along the sheet edge (e.g., the exposed width of about 10 um to 1 mm wide).

The material makeup of the mask depends, in part, on the composition of the etching media. In various embodiments the masks may be fabricated from metal and/or plastic layers.

For wet etching using a liquid solution of carbonic acid, as described, particularly useful masks may be made from chromium, titanium, aluminum, and nickel, for example. Titanium masks are particularly suitable for etching media based on acetic, formic, malonic, butyric and propionic acids. Nickel masks are particularly suitable for use with malonic, oxalic, and formic acids. And aluminum masks for use with propionic and butyric acid.

In various embodiments, a liquid mask may be employed. For instance mineral oil may be applied onto the surfaces of the sulfide glass solid electrolyte sheet or membrane and thereon serve as a masking overlayer. Methods for applying a mineral oil liquid mask include coating and printing techniques. In accordance with the present disclosure, in various embodiments the etching process may be incorporated as an inline station when fabricating a sulfide glass solid electrolyte sheet (e.g., using a drawdown process) and in particular for web and roll to roll manufacture. U.S. Pat. No. 10,164,289 describes manufacturing methods for making a web of sulfide glass solid electrolyte sheet (e.g., in line with drawing the sheet and trimming the edges to a certain width). In accordance with the present disclosure, wet etching processes, as disclosed herein, may be incorporated as an inline station for the web manufacture after the drawn down or otherwise processed sheet has been trimmed (e.g., mechanically sliced or laser cut).

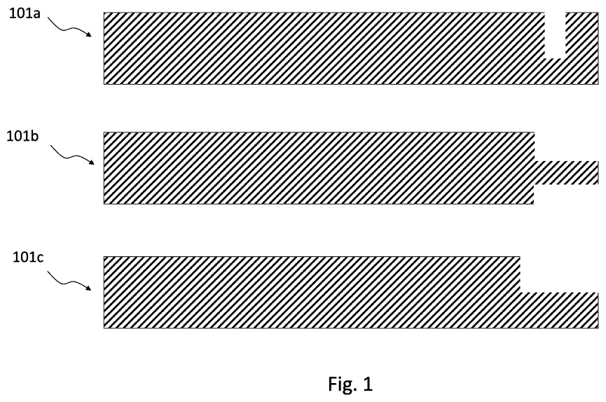

In various embodiments the chemical etching processes described herein may be applied to the edge surfaces of a sulfide glass solid electrolyte sheet to modify the edge shape for scaling the glass electrolyte when incorporated in a battery cell. In particular shaping the edges may be used to optimize edge sealing of the glass separator to an adjacent electrode (e.g., cathode or anode) or some other component in the battery cell. In FIG. 1 sulfide glass sheet/membranes 101a/b/c having various useful edge shapes, for example for facilitating sealing to adjacent battery cell components, are illustrated in cross sectional depiction. This approach is particularly useful for edge sealing in battery cells that include a liquid electrolyte that should be prevented from contacting the electroactive material of one of the electrodes.

### CONCLUSION

Although the foregoing has been described in some detail for purposes of clarity of understanding, it will be apparent that certain changes and modifications may be practiced within the scope of the appended claims. It should be noted that there are many alternative ways of implementing both the process and compositions of the present disclosure. Accordingly, the present embodiments are to be considered as illustrative and not restrictive, and the disclosure is not to be limited to the details given herein.

All references cited herein are incorporated by reference for all purposes.

1-20. (canceled)

21. A method for treating a surface of an ion conductive sulfide glass solid electrolyte, the method comprising exposing a surface or surface region of the sulfide glass solid electrolyte to an etching media, wherein water molecules are the etching media active etching species.

22. A method for treating a surface of an ion conductive sulfide glass solid electrolyte, the method comprising exposing a surface or surface region of the sulfide glass solid electrolyte to an etching media, wherein the etching media is a gaseous/vapor phase.

23. The method of claim 22 wherein the etching media further comprises a carrier gas that is inert in contact with the sulfide glass solid electrolyte.

24. The method of claim 23 wherein the inert carrier gas is nitrogen.

25. The method of claim 23 wherein the inert carrier gas is argon.

26. The method of claim 22 wherein the gaseous/vapor phase comprises water vapor as an active etchant.

27. The method of claim 22 wherein the gaseous/vapor phase comprises acid vapor as an active etchant.

28. The method of claim 27 wherein pressure regulation of the vapor is achieved in part by controlling the temperature and/or the ratio between the acid in the vapor phase and the carrier gas.

29. The method of claim 27 wherein the acid vapor comprises carbonic acid vapor.

30. A method for treating a surface of an ion conductive sulfide glass solid electrolyte, the method comprising exposing a surface or surface region of the sulfide glass solid electrolyte to an etching media, wherein the etching mechanism is hydrolysis.
